(19) United States
(12) Patent Application Publication
(10) Pub. No.: US 2022/0332271 A1
(43) Pub. Date: Oct. 20, 2022

(54) COMPONENT FOR VEHICLE INTERIOR

(71) Applicant: Shanghai Yanfeng Jinqiao Automotive Trim Systems Co. Ltd., Novi, MI (US)

(72) Inventors: Xinye DAI, Shanghai (CN); Jianfeng HOU, Shanghai (CN); Feng CUI, Shanghai (CN); Shuting HUANG, Shanghai (CN)

(21) Appl. No.: 17/854,107

(22) Filed: Jun. 30, 2022

Related U.S. Application Data
(63) Continuation-in-part of application No. PCT/CN2021/070415, filed on Jan. 6, 2021.

(30) Foreign Application Priority Data
Jan. 7, 2020 (CN) 202010013413.9

(51) Int. Cl. B60R 21/215

(52) U.S. Cl. CPC B60R 21/215; B60R 21/205

(57) ABSTRACT

A component for a vehicle interior is disclosed. The component may comprise an airbag door hinge coupled with an airbag door and a load-bearing component surrounding the door. The airbag door hinge may comprise a fabric layer configured to extend during deployment of an airbag. The fabric layer may comprise a mesh comprising a first segment of yarns and a second segment of yarns. The mesh may comprise a grid comprising multiple first segments and multiple second segments. Density of the first segment of yarns may differ from density of the second segment of yarns. The grid may comprise a first row of first segments spaced from one another by openings and a second row of second segments adjacent one another. The grid may comprise a third row of first segments spaced from one another by openings. The second row may separate the first and third rows.

### CROSS-REFERENCE TO RELATED APPLICATIONS

The present application is a continuation in part of PCT/International Patent Application No. PCT/CN2021/070415 filed Jan. 6, 2021, which claims the benefit of Chinese Patent Application No. 202010013413.9 filed on Jan. 7, 2020.

The present application claims priority to and incorporates by reference in full the following patent applications: (a) Chinese Patent Application No. 202010013413.9 filed on Jan. 7, 2020; (b) PCT/International Patent Application No. PCT/CN2021/070415 filed Jan. 6, 2021.

The present application is related to and incorporates by reference in full the following patent applications: (a) Chinese Patent Application No. 202010013686.3 filed on Jan. 7, 2020; (b) Chinese Utility Model Application No. 202020024604.0 filed Jan. 7, 2020 (now Chinese Utility Model No. 211417196U); (c) Chinese Utility Model Application No. 202020024585.1 filed Jan. 7, 2020 (now Chinese Utility Model No. 211364486U).

### FIELD

The present invention relates to a component for a vehicle interior.

The present invention also relates to a trim component for a vehicle interior comprising an airbag door hinge.

### BACKGROUND

It is known to provide a component for a vehicle interior comprising an airbag door and an airbag door hinge coupled with the airbag door.

It would be advantageous to provide a component with an improved airbag door hinge.

### SUMMARY

The present invention relates to a component for a vehicle interior comprising an airbag door, a load-bearing component surrounding the airbag door, and an airbag door hinge coupled with the airbag door and the load-bearing component. The airbag door hinge may comprise a fabric layer configured to extend in an extension direction during deployment of an airbag. The fabric layer may comprise a mesh comprising a first segment of yarns and a second segment of yarns. The mesh may comprise a grid comprising multiple first segments and multiple second segments. The first segment of yarns may comprise a density of yarns different than a density of yarns of the second segment of yarns. The grid may comprise a first row of first segments spaced from one another by openings in the mesh and a second row of second segments adjacent one another. The grid may comprise a third row of first segments spaced from one another by openings in the mesh. The first row may be separated from the third row by the second row.

The present invention relates to a component for a vehicle interior comprising an airbag door, a load-bearing component surrounding the airbag door, and an airbag door hinge coupled with the airbag door and the load-bearing component. The airbag door hinge may comprise a fabric layer configured to extend in an extension direction during deployment of an airbag. The fabric layer may comprise a mesh comprising a grid. The grid may comprise a first yarn extending in a first direction, a second yarn extending in a second direction generally perpendicular to the first direction and a third yarn extending in the second direction. The second yarn and the third yarn may be wound with the first yarn. The second yarn and the third yarn may extend in a zig zag to facilitate compression of the fabric layer. The second yarn may be arranged across the third yarn. The grid may comprise a first zone comprising openings in the grid, a third zone comprising openings in the grid offset from the openings of the first zone, and a second zone separating the first zone and the third zone.

The present invention relates to a component for a vehicle interior comprising an airbag door, a load-bearing component surrounding the airbag door, and an airbag door hinge. The airbag door hinge may be configured for connecting with the airbag door and the load-bearing component. The airbag door hinge may comprise a fabric layer. The fabric layer may comprise an extensible part comprising, based on a direction perpendicular to an extension direction of the extensible part, first zones and second zones disposed alternately. The first zones may comprise mesh openings arranged at intervals. The extensible part may comprise a first yarn, a second yarn and a third yarn; the first yarn may be arranged in a direction perpendicular to the extension direction. The second yarn and the third yarn may be routed in a direction perpendicular to the extension direction in a zigzag mode and may be wound with the first yarn. The second yarn may be cross-arranged with the third yarn. Boundaries of the first zone and the second zone may be defined by the first yarn and the second and/or third yarn wound therewith and thereby forming loops. The first zones may comprise the second yarn and/or the third yarn between two adjacent mesh openings. The second yarn and the third yarn may be routed in a direction perpendicular to the extension direction in a zigzag mode. The second zones may comprise the second yarn and/or the third yarn. The second yarn and the third yarn may be routed in a direction perpendicular to the extension direction in a zigzag mode. The mesh openings may be bounded in the extension direction by the first yarn, the second yarn and the third yarn. The mesh openings may be bounded by the crossed second and third yarn in a direction perpendicular to the extension direction. The extensible part may have an opening density of 1-10 openings/cm2. The mesh openings may have an area of 1-100 mm2. The extensible part may have a through-opening rate of 5-80%. An axis parallel to the extension direction in the mesh openings may have a length of 1-10 mm. An axis perpendicular to the extension direction in the mesh openings may have a length of 1-10 mm. An edge perpendicular to the extension direction in the mesh openings may have a length of 1-10 mm. An edge in the extension direction in the mesh openings may have a length of 1-10 mm. The extensible part may have an extension rate of 20-200% in the extension direction. The extensible part may have a breaking strength of 500-50,000 N/5 cm in the extension direction. The airbag door hinge may comprise a protective layer covering the fabric layer. The load-bearing component may comprise a framework and an airbag frame integrally formed with or connected with the framework. The framework may define an opening for deployment of an airbag therethrough. The airbag door may be configured to cover the opening. The airbag door hinge may be configured for connecting with the airbag door and the framework or the airbag frame.

The present invention relates to a component for a vehicle interior comprising an airbag door, a load-bearing component surrounding the airbag door, and an airbag door hinge. The airbag door hinge may be configured for connecting with the airbag door and the load-bearing component. The airbag door hinge may comprise a fabric layer. The fabric layer may comprise an extensible part comprising, based on a direction perpendicular to an extension direction of the extensible part, first zones and second zones disposed alternately, and the first zones may comprise mesh openings arranged at intervals. The mesh openings may comprise a substantially elliptical shape, and a ratio of a length of an axis parallel to the extension direction to a length of an axis perpendicular to the extension direction in the mesh openings may be 1:10 to 10:1, preferably 1:5 to 5:1, and more preferably 1:2 to 2:1. A plurality of the mesh openings may be arranged in the extension direction to form a plurality of rows of the mesh openings, and each row of the mesh openings may be staggered with adjacent rows of the mesh openings. The fabric layer may be woven from yarns. The extensible part may comprise a first yarn, a second yarn and a third yarn. The first yarn may be arranged in a direction perpendicular to the extension direction. The second yarn and the third yarn may be routed in a direction perpendicular to the extension direction in a zigzag mode and may be wound with the first yarn. The second yarn may be cross-arranged with the third yarn. Boundaries of the first zone and the second zone may be defined by the first yarn and the second and/or third yarn wound therewith and thereby forming loops. The first zones may comprise the second yarn and/or the third yarn between two adjacent mesh openings, and the second yarn and the third yarn may be routed in a direction perpendicular to the extension direction in a zigzag mode. The second zones may comprise the second yarn and/or the third yarn, and the second yarn and the third yarn may be routed in a direction perpendicular to the extension direction in a zigzag mode. The mesh openings may be bounded in the extension direction by the first yarn, the second yarn and the third yarn. The mesh openings may be bounded by the crossed second and third yarn in a direction perpendicular to the extension direction. The second yarn and/or the third yarn may each have an included angle of 1-89°, preferably 1-45°, with the extension direction. The extensible part may have an opening density of 1-10 openings/cm2. The mesh openings may have an area of 1-100 mm2. The extensible part may have a through-opening rate of 5-80%. The axis parallel to the extension direction in the mesh openings may have a length of 1-10 mm. The axis perpendicular to the extension direction in the mesh openings may have a length of 1-10 mm. An edge perpendicular to the extension direction in the mesh openings may have a length of 1-10 mm. An edge in the extension direction in the mesh openings may have a length of 1-10 mm. The extensible part may have an extension rate of 20-200% in the extension direction. The extensible part may have a breaking strength of 500-50,000 N/5 cm in the extension direction. The airbag door hinge may comprise a protective layer covering the fabric layer. The load-bearing component may comprise a framework and an airbag frame integrally formed with the framework. The framework may define an opening for deployment of an airbag therethrough. The airbag door may be configured to cover the opening. The airbag door hinge may be configured for connecting with the airbag door and the framework or the airbag frame. The load-bearing component may comprise a framework and an airbag frame connected with the framework. The framework may define an opening for deployment of an airbag therethrough. The airbag door may be configured to cover the opening. The airbag door hinge may be configured for connecting with the airbag door and the airbag frame.

### FIGURES

FIG. 1A is a schematic perspective view of a vehicle according to an exemplary embodiment.

FIG. 1B is a schematic perspective cut-away view of a vehicle showing a vehicle interior according to an exemplary embodiment.

FIG. 2A is a schematic perspective view of a component for a vehicle interior shown as an instrument panel according to an exemplary embodiment.

FIGS. 2B through 2D are schematic perspective detail views of an airbag deployment according to an exemplary embodiment.

FIG. 3 is a schematic partial section view of a component for a vehicle interior according to an exemplary embodiment.

FIGS. 4A and 4B are schematic partial cutaway plan views of a component for a vehicle interior according to an exemplary embodiment.

FIG. 5 is a schematic partial cutaway plan view of a component for a vehicle interior according to an exemplary embodiment.

FIGS. 6A through 6C are schematic partial cutaway plan views of a component for a vehicle interior according to an exemplary embodiment.

FIG. 7 is a schematic diagram of extension of a subcomponent of a component for a vehicle interior during an airbag deployment according to an exemplary embodiment.

FIG. 8 is a schematic diagram of extension of a subcomponent of a component for a vehicle interior during an airbag deployment according to an exemplary embodiment.

FIG. 9 is a schematic diagram of extension of a subcomponent of a component for a vehicle interior during an airbag deployment according to an exemplary embodiment.

FIG. 10A is a schematic partial section view of a component for a vehicle interior according to an exemplary embodiment.

FIG. 10B is a schematic partial section view of a component for a vehicle interior according to an exemplary embodiment.

FIG. 10C is a schematic partial section view of a component for a vehicle interior according to an exemplary embodiment.

FIG. 10D is a schematic partial section view of a component for a vehicle interior according to an exemplary embodiment.

### DESCRIPTION

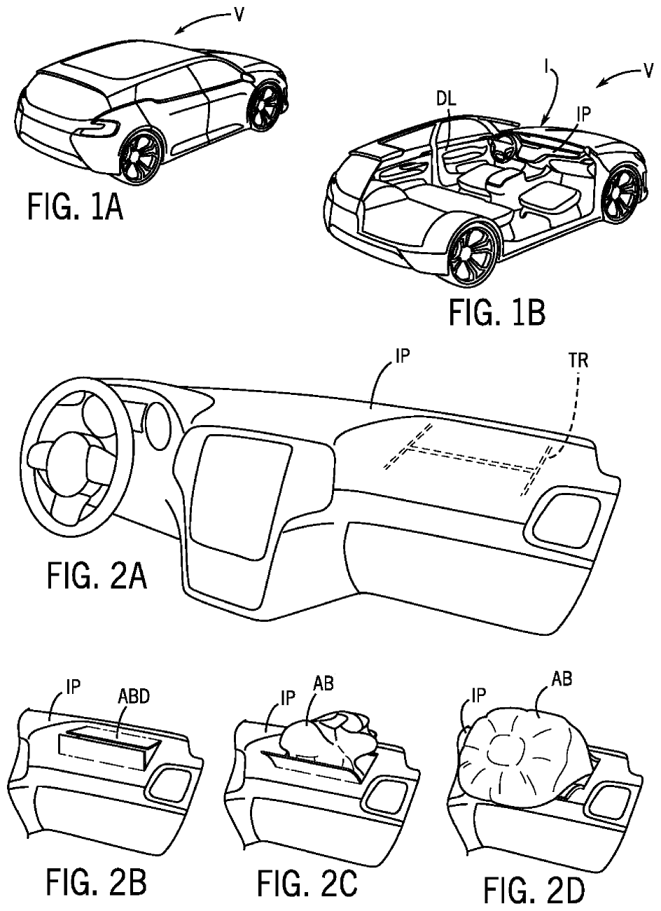

Referring to FIGS. 1A and 1B, a vehicle V is shown including an interior I with an instrument panel IP and doors DL. According to an exemplary embodiment, interior components of vehicle V such as instrument panel IP and doors DL may include trim panels. Instrument panel IP and doors DL may provide visible surfaces in the vehicle interior of vehicle V. Instrument panel IP and/or doors DL may provide at least one airbag AB behind the visible surfaces; instrument panel IP and/or doors DL may provide a weakened area to aid the airbag in breaking through the trim panel during airbag deployment. See FIGS. 2B-2D.

According to an exemplary embodiment as shown schematically in FIGS. 2A-2D, a component for a vehicle interior (such as a trim panel, instrument panel, etc.) may be configured to provide/support a module with an airbag configured to be deployed through an opening into the vehicle interior. As shown schematically in FIGS. 2A-2D, instrument panel IP may provide a weakened shape/zone shown as a recess TR to facilitate an airbag AB deployment through an airbag door ABD. The weakened shape/zone may comprise an “H” shape pattern, a “U” shape pattern, a “bow tie” shape pattern, or any pattern suitable for airbag deployment.

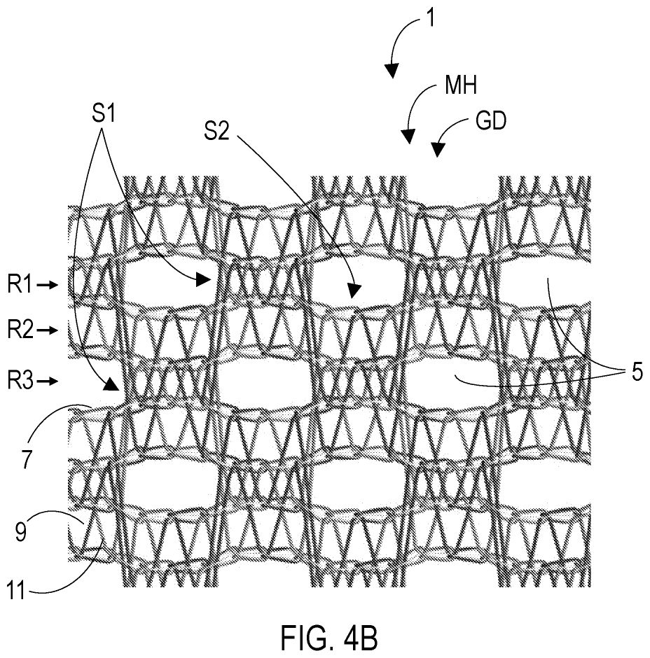

According to an exemplary embodiment as shown schematically in FIGS. 2A-2D, 3, 4A-4B, 5, 6A-6C, 7, 8, 9 and 10A-10D, a component for a vehicle interior may comprise an airbag door A1, a load-bearing component A2 surrounding the airbag door, and an airbag door hinge C1 coupled with the airbag door and the load-bearing component. The airbag door hinge may comprise a fabric layer 1 configured to extend in an extension direction during deployment of an airbag. The fabric layer may comprise a mesh MH comprising a first segment S1 of yarns and a second segment S2 of yarns. The mesh may comprise a grid GD comprising multiple first segments and multiple second segments. The first segment of yarns may comprise a density of yarns different than a density of yarns of the second segment of yarns. The grid may comprise a first row R1 of first segments spaced from one another by openings 5 in the mesh and a second row R2 of second segments adjacent one another. The grid may comprise a third row R3 of first segments spaced from one another by openings in the mesh. The first row may be separated from the third row by the second row. See FIG. 4B.

According to an exemplary embodiment as shown schematically in FIGS. 2A-2D, 3, 4A-4B, 5, 6A-6C, 7, 8, 9 and 10A-10D, a component for a vehicle interior may comprise an airbag door A1, a load-bearing component A2 surrounding the airbag door, and an airbag door hinge C1 coupled with the airbag door and the load-bearing component. The airbag door hinge may comprise a fabric layer 1 configured to extend in an extension direction during deployment of an airbag. The fabric layer may comprise a mesh MH comprising a grid GD. The grid may comprise a first yarn 7 extending in a first direction, a second yarn 9 extending in a second direction generally perpendicular to the first direction and a third yarn 11 extending in the second direction. The second yarn and the third yarn may be wound with the first yarn. The second yarn and the third yarn may extend in a zig zag to facilitate compression of the fabric layer. The second yarn may be arranged across the third yarn. The grid may comprise a first zone Z1 comprising openings 5 in the grid, a third zone Z3 comprising openings 5 in the grid offset from the openings of the first zone, and a second zone Z2 separating the first zone and the third zone. See FIG. 4A.

According to an exemplary embodiment as shown schematically in FIGS. 2A-2D, 3, 4A-4B, 5, 6A-6C, 7, 8, 9 and 10A-10D, a component for a vehicle interior may comprise an airbag door A1, a load-bearing component A2 surrounding the airbag door, and an airbag door hinge C1. The airbag door hinge may be configured for connecting with the airbag door and the load-bearing component. The airbag door hinge may comprise a fabric layer 1. The fabric layer may comprise an extensible part comprising, based on a direction perpendicular to an extension direction of the extensible part, first zones Z1 and second zones Z2 disposed alternately. The first zones may comprise mesh openings 5 arranged at intervals. The extensible part may comprise a first yarn 7, a second yarn 9 and a third yarn 11; the first yarn may be arranged in a direction perpendicular to the extension direction. The second yarn and the third yarn may be routed in a direction perpendicular to the extension direction in a zigzag mode and may be wound with the first yarn. The second yarn may be cross-arranged with the third yarn. Boundaries of the first zone and the second zone may be defined by the first yarn and the second and/or third yarn wound therewith and thereby forming loops. The first zones may comprise the second yarn and/or the third yarn between two adjacent mesh openings. The second yarn and the third yarn may be routed in a direction perpendicular to the extension direction in a zigzag mode. The second zones may comprise the second yarn and/or the third yarn. The second yarn and the third yarn may be routed in a direction perpendicular to the extension direction in a zigzag mode. The mesh openings may be bounded in the extension direction by the first yarn, the second yarn and the third yarn. The mesh openings may be bounded by the crossed second and third yarn in a direction perpendicular to the extension direction. The extensible part may have an opening density of 1-10 openings/cm2. The mesh openings may have an area of 1-100 mm2. The extensible part may have a through-opening rate of 5-80%. An axis a parallel to the extension direction in the mesh openings may have a length of 1-10 mm. An axis b perpendicular to the extension direction in the mesh openings may have a length of 1-10 mm. An edge perpendicular to the extension direction in the mesh openings may have a length of 1-10 mm. An edge in the extension direction in the mesh openings may have a length of 1-10 mm. The extensible part may have an extension rate of 20-200% in the extension direction. The extensible part may have a breaking strength of 500-50,000 N/5 cm in the extension direction. The airbag door hinge may comprise a protective layer 3 covering the fabric layer. The load-bearing component may comprise a framework A21 and an airbag frame A22 integrally formed with or connected with the framework. The framework may define an opening for deployment of an airbag therethrough. The airbag door may be configured to cover the opening. The airbag door hinge may be configured for connecting with the airbag door and the framework or the airbag frame.

### Exemplary Embodiments—A

As one of ordinary skill in the art will appreciate that various characteristics of the embodiments illustrated and described with reference to any one of the accompanying drawings may be combined with characteristics illustrated in one or more other accompanying drawings to produce other embodiments that are not explicitly illustrated or described. The combination of the characteristics shown provides a representative embodiment for typical application. However, various combinations and modifications of the characteristics consistent with the teachings disclosed herein may be desired for particular application or implementation.

In the specification, the directional terms such as “upper”, “lower”, “left”, and “right” are used for convenience of description, and are not restrictive.

For the terms “first” and “second” used herein for the designations of components in the same relationship, the present invention is not limited to the order described herein.

The term “one or more” or “at least one” used herein represents one, two, three, four, five, six, seven, eight or more.

The terms “about” and “approximately”, when used in conjunction with a numerical variable, generally mean that the value of the variable and all values of the variable are within experimental error (e.g., within a 95% confidence interval for the mean) or within ±10% of the specified value, or more.

In the specification, the term “vehicle” or other similar terms generally includes motor vehicles, such as passenger vehicles including sports utility vehicles (SUVs), buses, trucks, and various commercial vehicles, watercrafts including a variety of ships and boats, aircrafts, and the like; and includes hybrid vehicles, electric vehicles, plug-in hybrid electric vehicle, hydrogen-powered vehicles, and other alternative-fuel vehicles (e.g., powered by energy sources other than petroleum). The hybrid vehicles are ones having two or more power sources, such as gasoline and electric hybrid vehicles.

In the specification, the term “extension rate” refers to a ratio of the increased (stretched) length to an original length of a fabric when it is stretched until it breaks. Measurements are typically made using a method well known in the art, such as ISO 13934. The extension rate used herein refers to an extension rate in an extension direction.

In the specification, the term “opening density” refers to a number of mesh openings per unit area (cm2).

In the specification, the term “breaking strength” refers to a ratio of the tension to the broken cross-sectional area, i.e., the stress, at which a material breaks. Measurements are typically made using a method well known in the art, such as ISO 13934. The breaking strength used herein refers to a breaking strength in an extension direction.

In the specification, the term “extension direction” refers to a direction in which a fabric is stretched and extended, i.e., a direction in which an extensible part of the fabric is stretched, and also a direction in which a force is applied for the deployment of an airbag. The term “perpendicular to an extension direction” or “a direction perpendicular to the extension direction” refers to a direction perpendicular to an “extension direction” in the plane of a fabric layer, which may also be referred to as a “transverse direction”.

In the specification, a size of a mesh opening is defined by a length of an edge of the mesh opening perpendicular to an extension direction and a length of the edge of the mesh opening in the extension direction. The size of the mesh opening only refers to a size of the area of the mesh opening and does not comprise a width or a size of a yarn itself.

In the specification, the term “through-opening rate” refers to a proportion of an area of the mesh opening part to a total area of an extensible part.

In the specification, the term “airbag door” may also be referred to as an airbag cover having the meaning commonly referred to in the art. When a vehicle airbag assembly is triggered, the airbag door opens, so that the airbag is deployed outward from a space defined by the airbag door and load-bearing component.

In the specification, the “component for a vehicle interior” is a part of an instrument panel.

The weaving of yarns may be performed by a weaving machine. The weaving machine may be, for example, a warp weaving machine or a weft weaving machine, preferably a warp weaving machine. The weaving machine may help to achieve a fabric layer with good stretchability and extensibility. The yarns may be subjected to a looping motion to form loops. The loops may be mutually staggered to form connections in a stringing and sleeving manner. The yarns may also be crossed. The yarns may also be wound with loops, thereby forming a fabric layer by the weaving of the yarns.

The present invention relates to a component for a vehicle interior comprising an airbag door, a load-bearing component surrounding the airbag door, and an airbag door hinge. The airbag door hinge may be configured for connecting with the airbag door and the load-bearing component.

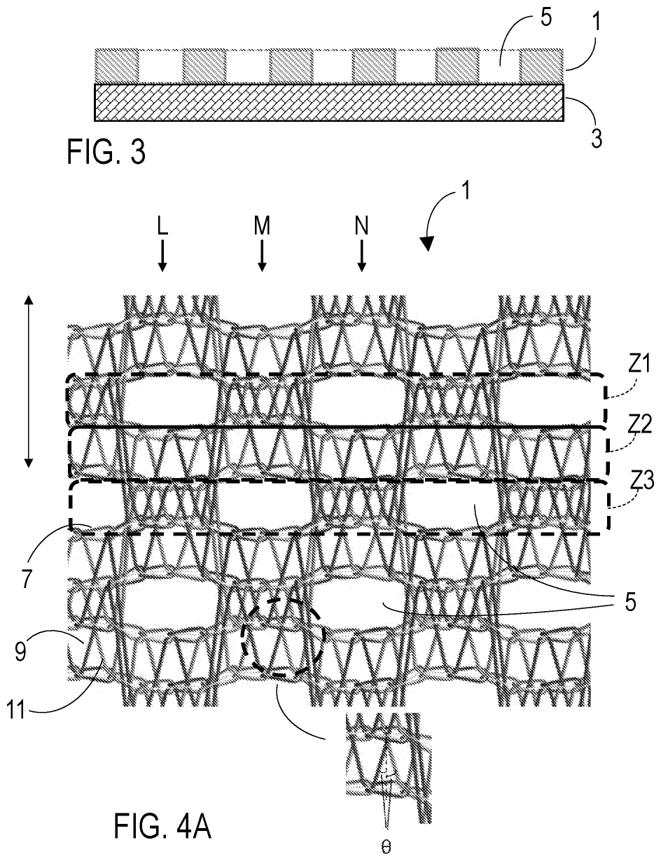

FIG. 3 is a schematic side view of an airbag door hinge according to an exemplary embodiment. As shown schematically in FIG. 3, the airbag door hinge may comprise a fabric layer 1 and a protective layer 3. The protective layer 3 may cover the fabric layer 1. The protective layer 3 may comprise a single-layer structure and may be made of at least one material, such as non-woven fabric, masking tape, and plastic film. The protective layer 3 may be connected with the fabric layer 1 by bonding, sewing, compounding, and other processes. The protective layer 3 may be configured to block an injection molding flow during injection molding to protect the fabric layer 1 from being damaged.

The fabric layer 1 may be woven from yarns. The fabric layer 1 may comprise an extensible part that can be stretched by a force generated by the airbag door when the airbag door opens and rotates. The extensible part may be located at a position where the airbag door connects with the load-bearing component. The fabric layer 1 may be an extensible part as a whole, or a portion of the fabric layer 1 may be an extensible part.

FIG. 4A is a schematic view of an extensible part of an airbag door hinge according to an exemplary embodiment. A direction indicated by the double arrow is an extension direction. As shown schematically in FIG. 4A, the extensible part may comprise, based on a direction perpendicular to an extension direction of the extensible part, first zones Z1 and second zones Z2 disposed alternately, and the first zones Z1 comprise mesh openings arranged at intervals. FIG. 3 (a schematic side view of the fabric layer 1) is a schematic side view of the extensible part of the fabric layer 1 in a cross-sectional direction of the first zone Z1, showing mesh openings 5 arranged at intervals.

The fabric layer 1 is woven from yarns of one or more materials which include, but are not limited to, synthetic fibers, natural fibers, or a combination thereof, preferably polyethylene, polypropylene, regenerated cellulose fibers, polyamides, carbon fibers, polyacrylonitrile, polyesters, cellulose, cotton, sisal hemp, abaca, kapok, ramie, flax, hemp, jute, animal hair, silk, or a combination thereof, e.g., polyester, aramid, nylon and suplon. For example, the material of yarns may be polyester 300D and polyester 150D.

The weaving of yarns includes the winding and crossing of a yarn itself or between the yarns, the winding and crossing of loops formed from the yarns, and the winding and crossing between the loops formed from the yarns and the yarns.

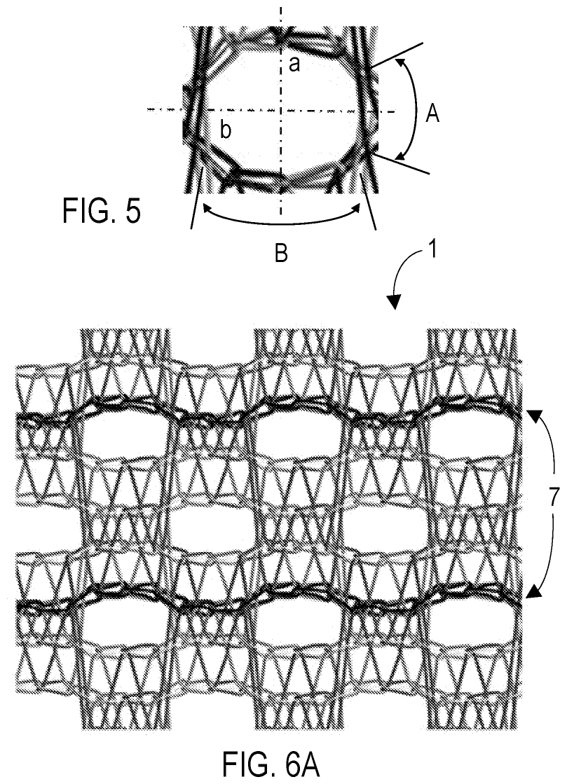

FIG. 5 is a partially enlarged schematic view of an extensible part of an airbag door hinge according to an exemplary embodiment. As shown schematically in FIG. 5, the mesh openings have a substantially elliptical shape. A ratio of an axis a parallel to an extension direction to an axis b perpendicular to the extension direction in the mesh openings is about 1:10 to 10:1, preferably about 1:5 to 5:1, and more preferably about 1:2 to 2:1, such as about 1:1 to 3:5, and 2:5 to 3:5. The elliptical shape used herein includes a circular shape.

According to an exemplary embodiment, a length of an axis a parallel to an extension direction is less than a length of an axis b perpendicular to the extension direction in the mesh openings. In this case, the mesh openings have an elliptical shape.

According to an exemplary embodiment, a length of an axis a parallel to an extension direction is equal to a length of an axis b perpendicular to the extension direction in the mesh openings. In this case, the mesh openings have a circular shape.

According to an exemplary embodiment, a length of an axis a parallel to an extension direction is greater than a length of an axis b perpendicular to the extension direction in the mesh openings. In this case, the mesh openings have an elliptical shape.

According to an exemplary embodiment, an axis a may have a length of 1-10 mm, preferably 1.5-5 mm, e.g., about 2, 3, and 4 mm.

According to an exemplary embodiment, an axis b may have a length of 1-10 mm, preferably 1.5-5 mm, e.g., about 2, 3, and 4 mm.

When the extensible part is in a stretched state, a ratio of a length of an axis a to a length of an axis b is greater than that in an unstretched state.

The arrangement of mesh openings at intervals helps to provide sufficient space for the mesh openings during stretch deformation, thereby helping to achieve stretch deformation of the extensible part and increasing extension rate. As shown schematically in FIG. 4A, a plurality of the mesh openings 5 are arranged in the extension direction to form a plurality of rows of the mesh openings, and each row of the mesh openings are staggered with adjacent rows of the mesh openings. That is, each row of the mesh opening are not aligned with adjacent rows of the mesh openings. For example, as illustrated in FIG. 4A, the Mth row of the mesh openings are staggered with the adjacent Lth and Nth rows of the mesh openings. Further, the Lth row of the mesh openings are aligned with the Nth row of the mesh openings. Likewise, the mesh openings in two adjacent first zones Z1 are staggered in a direction perpendicular to the extension direction. That is, the mesh openings in the two adjacent first zones Z1 are not aligned. As a whole, the plurality of the mesh openings 5 are aligned neither in the extension direction of the extensible part nor in a direction perpendicular to the extension direction, but are arranged in a staggered array.

The specific structure of the extensible part of the fabric layer of the airbag door hinge according to an exemplary embodiment is described below. According to an exemplary embodiment as shown schematically in FIG. 4A, the extensible part may comprise a first yarn 7, a second yarn 9, and a third yarn 11. The first yarn 7, the second yarn 9 and the third yarn 11 may be of the same material or of different materials. The first yarn 7, the second yarn 9 and the third yarn 11 may be the same or different in thickness and specification. The three yarns may be connected in a form of mutually winding or crossing by every two yarns, or in a form of winding or crossing after forming loops by every two yarns, or in a form of winding or crossing by the yarns and the loops. The plurality of the mesh openings 5 are formed by the connection arrangement of the first yarn 7, the second yarn 9 and the third yarn 11.

The first yarn 7 is arranged in a direction perpendicular to the extension direction. The second yarn 9 and the third yarn 11 are routed in a direction perpendicular to the extension direction in a zigzag mode and are wound with the first yarn 7. The second yarn 9 is cross-arranged with the third yarn 11.

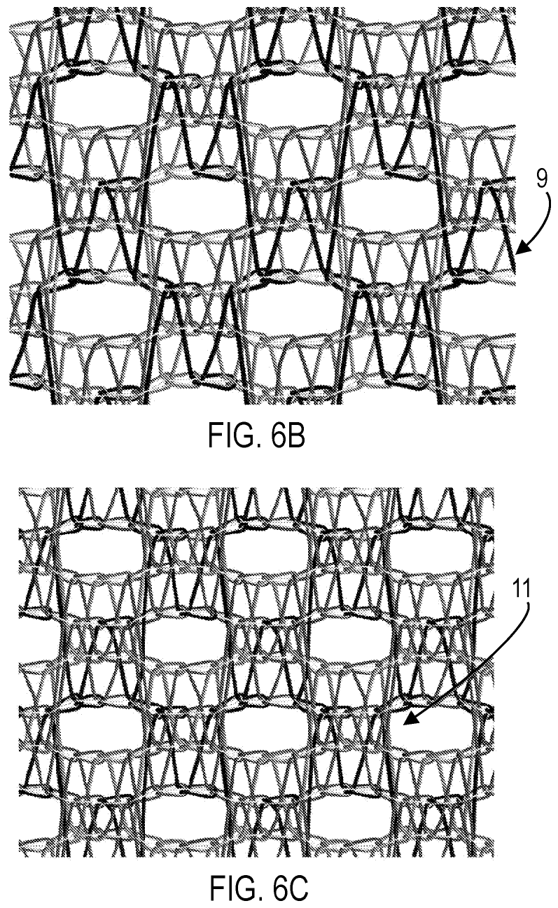

FIGS. 6A-6C show specific connection forms of the yarns in the extensible part in the embodiment of FIG. 4A. For the sake of clarity, the yarns shown schematically in detail in FIG. 6A-6C are shown in bold. The bold does not represent the actual thickness of the yarn in this embodiment, but merely to show the routes of the yarns more clearly herein. The first yarn 7 is routed as shown by the bold yarn in FIG. 6A. The second yarn 9 is routed as shown by the bold yarn in FIG. 6B. The third yarn 11 is routed as shown by the bold yarn in FIG. 6C.

According to an exemplary embodiment as shown schematically in FIG. 6A, the first yarn is arranged in a form of loops in a direction perpendicular to the extension direction, and is connected in a stringing and sleeving manner. As shown schematically in FIG. 6B and FIG. 6C, the second yarn 9 and the third yarn 11 each are wound with the first yarn 7, forming intersections of the second yarn 9 and the third yarn 11 with the first yarn 7. At the intersection with the first yarn 7, the second yarn 9 and the third yarn 11 each are wound and connected with the first yarn 7 in a form of loops. Such an arrangement facilitates the formation of the extensible part.

According to an exemplary embodiment, the second yarn and third yarn may also be the woven yarns.

According to an exemplary embodiment as shown schematically in FIG. 4A, boundaries of the first zone Z1 and the second zone Z2 are defined by the first yarn 7 and the second yarn 9 and/or third yarn 11 wound therewith and thereby forming loops.

According to an exemplary embodiment, two adjacent mesh openings in the first zone Z1 comprise the second yarn 9 and/or the third yarn 11. The second yarn 9 and the third yarn 11 are routed in a direction perpendicular to the extension direction in a zigzag mode. Such an arrangement facilitates compressive deformation of the extensible part in a direction perpendicular to the extension direction. According to an exemplary embodiment, a length in the extension direction between two adjacent mesh openings in first zones Z1 is close to a length of an axis a of the opening mesh in an unstretched state. A length in a direction perpendicular to the extension direction is close to a length of the axis b of the mesh opening.

According to an exemplary embodiment, the second zone Z2 does not comprise a mesh opening structure as described herein. Second zones Z2 comprise a second yarn 9 and/or a third yarn 11. The second yarn 9 and the third yarn 11 are routed in a direction perpendicular to the extension direction in a zigzag mode. Such an arrangement provides sufficient space for the mesh openings during stretch deformation, thereby helping to achieve stretch deformation of the extensible part in the extension direction and increasing extension rate. Such an arrangement also facilitates the connection between the mesh openings so that the extensible part may form a fabric surface, thereby helping to provide the desired stretch strength of the extensible part. According to an exemplary embodiment, second zones Z2 have a length in the extension direction of about 1-10 mm, preferably 1.5-5 mm.

According to an exemplary embodiment as shown schematically in FIG. 4A, the mesh openings 5 are bounded in the extension direction by the first yarn 7, the second yarn 9 and the third yarn 11. According to an exemplary embodiment as shown schematically in FIGS. 6A-6C, the mesh openings 5 are bounded in the extension direction by the first yarn 7, the second yarn 9 and the third yarn 11 woven into loops.

According to an exemplary embodiment as shown schematically in FIG. 4A, the mesh openings 5 are bounded by the crossed second yarn 9 and third yarn 11 in a direction perpendicular to the extension direction. Since the mesh opening 5 is woven from yarns, and the boundaries thereof are also defined by the various connection arrangements of the yarns, it has not an absolutely perfectly elliptical shape, but a substantially elliptical shape. In other embodiments, the mesh opening may also have an elliptical-like shape, including but not limited to, an oblong shape, a polygonal shape, and a rectangular shape.

As shown schematically in FIG. 5, a length B of an edge of the mesh opening 5 in a direction perpendicular to the extension direction is defined as a length of an edge of the mesh opening 5 formed by the first yarn 7, the second yarn 9 and the third yarn 11. A length A of an edge of the mesh opening 5 in the extension direction is defined as a length of an edge of the mesh opening 5 in the extension direction formed by the crossed second yarn 9 and third yarn 11. The length A of the edge and length B of the edge each are a length of an edge of the mesh opening on one side.

According to an exemplary embodiment, where a length B of an edge is greater than a length A of an edge, the mesh opening 5 may have a substantially elliptical shape. According to an exemplary embodiment, where a length B of an edge is equal to a length A of an edge, the mesh opening 5 have a circular shape. According to an exemplary embodiment, where a length B of an edge is less than a length A of an edge, the mesh opening 5 may have a substantially elliptical shape.

According to an exemplary embodiment, an edge of the mesh opening 5 may have a length B of about 1-10 mm, preferably about 2-6 mm, e.g., about 2, 3, and 4 mm.

According to an exemplary embodiment, an edge of the mesh opening 5 may have a length A of about 1-10 mm, preferably about 2-6 mm, e.g., about 2, 3, and 4 mm.

According to an exemplary embodiment, the mesh opening may have an area of about 1-100 mm2, preferably from about 5-30 mm2, e.g., about 7, and 15 mm2. The area of the mesh opening refers to an area of a single mesh opening.

According to an exemplary embodiment, the through-opening rate is about 5-80%, preferably about 25-60%, e.g., about 30%, and 40%.

According to an exemplary embodiment, the extensible part may have an opening density of about 1-10 openings/cm2, preferably about 3-6 openings/cm2, e.g., about 5 openings/cm2.

According to an exemplary embodiment as shown schematically in FIG. 4A, the second yarn and/or the third yarn have an included angle θ of 1-89°, preferably 1-45°, e.g., 15, 20, 30, 40, and 60° with the extension direction.

The setting of parameters such as the mesh opening shape, the mesh opening area, the through-opening rate, the opening density, the included angle between the second yarn and/or the third yarn and the extension direction and other parameters helps to obtain the extensible part with different extensibility to a certain extent, thereby achieving the effect of controllable extension. The extensible part may have an extension rate of about 20-200% in the extension direction, preferably about 50-200%, e.g., about 100%, 150%, and 200%. Such extensibility helps to prevent the airbag door from separating from the load-bearing component. The limitation of parameters of the mesh openings described herein enables structural deformation of the extensible part, which further increases the extensibility of the extensible part, and can reduce the tension applied to the extensible part in the opening process of the airbag door, so that the risk that the fabric layer is broken due to excessive shearing tension applied to the fabric layer is avoided.

According to the extensible part of the airbag door hinge of the present invention, different breaking strengths can be achieved according to the adopted yarn materials, the arrangement of the yarns and mesh openings and other factors, thereby achieving the effect of adjustable breaking strength. The extensible part may have a breaking strength of 500-50,000 N/5 cm, preferably about 600-5000 N/5 cm, e.g., about 800, 1500, and 2000 N/5 cm.

Both ends of the airbag door hinge according to the present invention in the extension direction can be connected with the airbag door and the load-bearing component surrounding the airbag door, respectively, for example, by injection molding. When the vehicle airbag assembly is triggered, where the airbag door opens from one side, the airbag door rotates around the airbag door hinge as a whole. Alternatively, for an airbag door that opens from a middle to both sides, airbag door hinges are provided at both ends of the airbag door, such that when the vehicle airbag assembly is triggered, both halves of the airbag door rotate about the airbag door hinges. The following embodiments illustrate a scheme in which the airbag door opens from one side, but such embodiments are merely exemplary to illustrate the connection relationship of the airbag door hinge with the airbag door and the load-bearing component. As described above, the component for a vehicle interior may comprise a scheme in which the airbag door opens from a middle to both sides.

According to an exemplary embodiment, the load-bearing component may comprise: a framework and an airbag frame integrally formed with the framework. The framework may define an opening for deployment of an airbag therethrough. The airbag door may be configured to cover the opening, and the airbag door hinge my connect the airbag door and the framework.

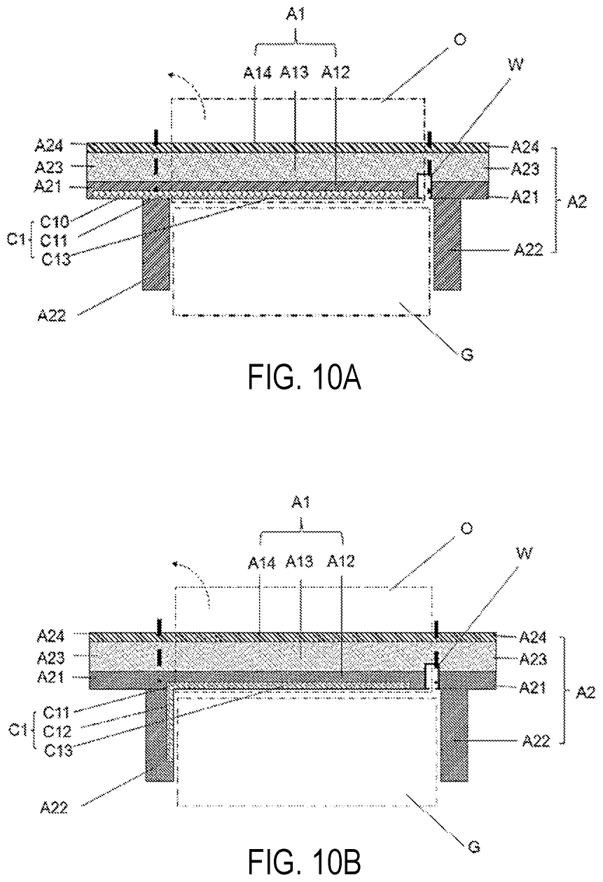

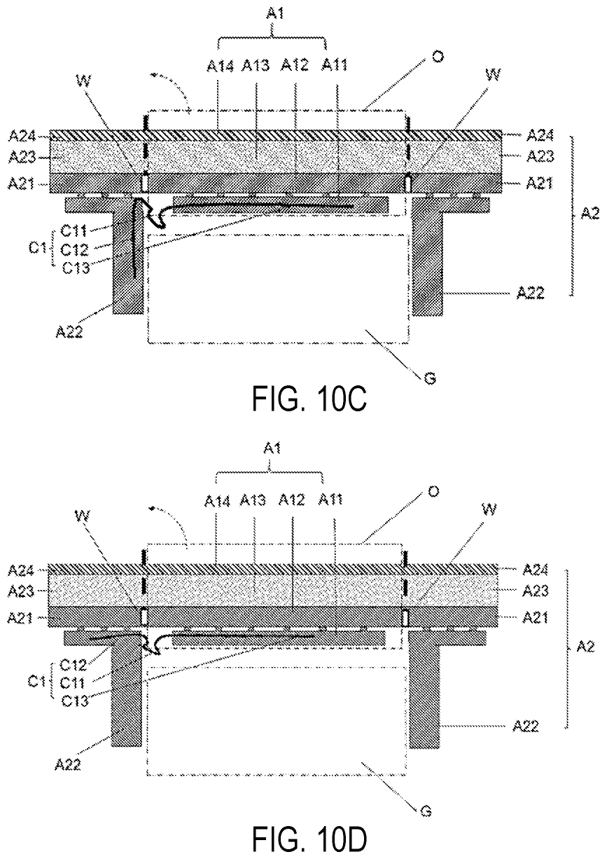

FIG. 10A is a schematic view of a vehicle interior trim comprising an airbag door hinge according to a specific embodiment of the present invention, showing the location of an embodiment for the airbag door hinge. According to an exemplary embodiment as shown schematically in FIG. 10A, the component for a vehicle interior comprises: an airbag door A1 (the assembly indicated by the bold dashed lines), a load-bearing component A2 surrounding the airbag door A1, and an airbag door hinge C1. The hinge C1 may be configured to connect with the airbag door A1 and the load-bearing component A2. The connection may be achieved, for example, using an insert injection molding process.

The load-bearing component A2 may comprise a framework A21 and an airbag frame A22 integrally formed with the framework A21. The framework A21 defines an opening O for deployment of the airbag G therethrough. According to an exemplary embodiment, the load-bearing component A2 may comprise a load-bearing component foam layer A23 and/or a load-bearing component skin layer A24. The load-bearing component foam layer A23 and the load-bearing component skin layer A24 may be sequentially arranged on the side of the framework A21 remote from the airbag frame A22. The load-bearing component foam layer A23 and the load-bearing component skin layer A24 may be composed of the same material or different materials.

The airbag door A1 may be configured to cover the opening O. The airbag door A1 may comprise an airbag door substrate A12, and optionally an airbag door foam layer A13 and an airbag door skin layer A14, which are sequentially arranged from bottom to top. The airbag door hinge C1 may be configured for connecting with the airbag door substrate A12 and the framework A21. The airbag door hinge C1 may comprise fixed segments C10 and C13, and a hinge segment C11. The fixed segments C10 and C13 are fixed in the framework A21 and the airbag door substrate A12, respectively. According to an exemplary embodiment, the hinge segment C11 is also fixed in the framework A21 and the airbag door substrate A12. The fixing is achieved by embedding. Such a fixing mode ensures that the hinge segment C11 is not in a loosening state. The airbag door foam layer A13 and the airbag door skin layer A14 may have the same material composition or different material compositions. The fabric layer of the hinge C1, in particular the hinge segment C11, may comprise an extensible part described herein.

According to an exemplary embodiment, the load-bearing component foam layer A23 and the airbag door foam layer A13 have the same material composition. The load-bearing component skin layer A24 and the airbag door skin layer A14 have the same material composition.

According to an exemplary embodiment, the framework A21 and the airbag door substrate A12 have the same material composition. According to an exemplary embodiment, the framework A21 is integrally formed with the airbag door substrate A12.

The framework A21 may comprise a weakened zone W arranged in the opening covered by the airbag door, on the side remote from the connection of the hinge C1 with the framework A21. The weakened zone W is arranged such that the intersection of the airbag door substrate A12 and the framework A21 has a weaker mechanical strength than the other parts of the airbag door substrate A12 and the framework A21, so that the airbag door can be easily opened and the airbag is deployed from the airbag frame towards the airbag door. The depth of the weakened zone may optionally extend from the framework A21 to the foam layer A23, but should not extend to the skin layer A24. A direction indicated by the dotted arrow in FIG. 10A is a direction in which the airbag door opens.

According to an exemplary embodiment, the load-bearing component may comprise a framework and an airbag frame integrally formed with the framework. The framework may define an opening for deployment of an airbag therethrough, the airbag door may be configured to cover the opening, and the airbag door hinge may be configured for connecting with the airbag door and the airbag frame.

FIG. 10B is a schematic view of a vehicle interior trim comprising an airbag door hinge according to another specific embodiment of the present invention, showing the location of another embodiment for the airbag door hinge. In this embodiment, similar to the case in FIG. 10A, the load-bearing component A2 may comprise a framework A21 and an airbag frame A22 integrally formed with the framework A21. The airbag door hinge C1 may be configured for connecting with the airbag door A1 and the airbag frame A22. The hinge C1 may comprise fixed segments C12 and C13, and a hinge segment C11. The hinge segment C11 is fixed in the airbag frame A22 and the airbag door substrate A12, and the fixed segments C12 and C13 of the hinge C1 are fixed in the airbag frame A22 and the airbag door substrate A12, respectively.

According to an exemplary embodiment, the load-bearing component may comprise a framework and an airbag frame connected with the framework. The framework may define an opening for deployment of an airbag therethrough. The airbag door may be configured to cover the opening. The airbag door hinge may be configured to connect with the airbag door and the airbag frame.

FIG. 10C is a schematic view of a vehicle interior trim comprising an airbag door hinge according to yet another embodiment of the present invention, showing the location of another embodiment for the airbag door hinge. According to an exemplary embodiment as shown schematically in FIG. 10C, the component for a vehicle interior comprises: an airbag door A1 (the assembly indicated by the bold dashed lines), a load-bearing component A2 surrounding the airbag door A1, and an airbag door hinge C1. The hinge C1 may be configured to connect with the airbag door A1 and the load-bearing component A2. The connection may be achieved, for example, using an insert injection molding process.

The load-bearing component A2 may comprise a framework A21 and an airbag frame A22 connected with the framework A21. The framework A21 defines an opening O for deployment of the airbag G therethrough. The connection mode includes, but is not limited to, welding, bonding, riveting, screwing, and hooking, preferably welding. According to an exemplary embodiment, the load-bearing component A2 may comprise a load-bearing component foam layer A23 and/or a load-bearing component skin layer A24. The load-bearing component foam layer A23 and the load-bearing component skin layer A24 are sequentially arranged on the side of the framework A21 remote from the airbag frame A22. The load-bearing component foam layer A23 and the load-bearing component skin layer A24 may be composed of the same material or different materials.

The airbag door A1 may be configured to cover the opening. The airbag door A1 may comprise a reinforcing door A11, an airbag door substrate A12, and optionally an airbag door foam layer A13 and an airbag door skin layer A14, which are sequentially arranged from bottom to top. The connection mode of the reinforcing door A11 and the airbag door substrate A12 includes, but is not limited to, welding, bonding, riveting, screwing and hooking, preferably welding. The airbag door foam layer A13 and the airbag door skin layer A14 may have the same material composition or different material compositions.

According to an exemplary embodiment, the load-bearing component foam layer A23 and the airbag door foam layer A13 have the same material composition. The load-bearing component skin layer A24 and the airbag door skin layer A14 have the same material composition.

According to an exemplary embodiment, the framework A21 and the airbag door substrate A12 have the same material composition. According to an exemplary embodiment, the framework A21 is integrally formed with the airbag door substrate A12.

The airbag door hinge C1 may be configured to connect with the reinforcing door A11 in the airbag door and the airbag frame A22. The airbag door hinge C1 may comprise fixed segments C12 and C13, and a hinge segment C11. The fixed segments C12 and C13 may be fixed in the airbag frame A22 and the reinforcing door A11 in the airbag door A1, respectively. As shown schematically in FIG. 8C, the fixed segment C12 may be fixed to a part in the airbag frame A22 defining the airbag. The fixed segment C12 may also be fixed to a part in the airbag frame A22 connecting with the framework A21, as shown schematically in FIG. 10D.

The hinge segment C11 is in a loosening state as shown schematically in FIG. 10C and FIG. 10D. The fabric layer of the hinge C1, in particular the hinge segment C11, may comprise an extensible part described herein.

The framework A21 may comprise a weakened zone W arranged on both sides of the opening covered by the airbag door so that the airbag door can be easily opened and the airbag is deployed from the airbag frame towards the airbag door. The depth of the weakened zone may optionally extend from the framework A21 to the foam layer A23, but should not extend to the skin layer A24. A direction indicated by arrows in FIG. 10C and FIG. 10D is a direction in which the airbag door opens.

According to an exemplary embodiment, a framework A21 and an airbag frame A22 are of materials commonly used in the art, including but not limited to, polyvinyl chloride, polypropylene, polyacrylonitrile-butadiene-styrene, polyester, and polyurethane.

### Embodiment 1

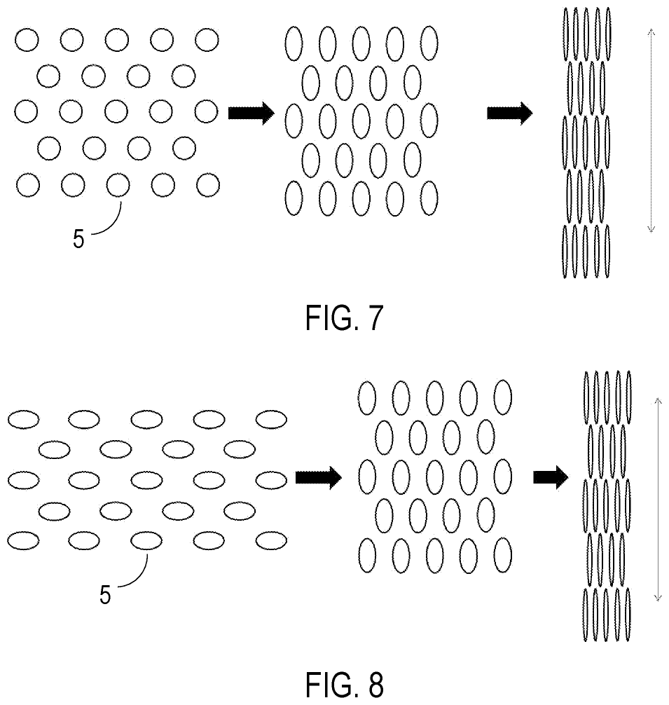

FIG. 7 is a schematic view of an extensible part of an airbag door hinge according to Embodiment 1 of the present invention, wherein the extensible part is stretched from an unstretched state to a stretched state until it is stretched to a limit. A direction of the double arrow in FIG. 7 is an extension direction. In this embodiment, a length of an axis b perpendicular to the extension direction in the mesh opening 5 is equal to a length of an axis a parallel to the extension direction in the mesh opening 5. That is, the mesh opening 5 may have a circular shape. When the airbag door opens, the airbag door hinge is stretched by the deformation of the mesh opening 5, serving an extension function. When the mesh opening 5 is stretched to a limit, the fabric layer begins to exert a restraining effect on the airbag door.

The yarns are woven using the weaving mode in FIG. 4A. The second yarn and the third yarn each have an included angle θ of 15-30°, preferably 20°, with the extension direction.

A ratio of the length of the axis a parallel to the extension direction to the length of the axis b perpendicular to the extension direction is 1:1. The axis a may have a length of 3 mm. The axis b may have a length of 3 mm. An edge perpendicular to the extension direction in the mesh opening may have a length of 3 mm, and an edge in the extension direction in the mesh opening may have a length of 3 mm. The mesh opening may have an area of 7 mm2. The extensible part may have an opening density of 5 openings/cm2. The extensible part may have a through-opening rate of 30%.

The first yarn, the second yarn and the third yarn may all use polyester yarn 300D. The extensible part may have an extension rate of 150% in the extension direction. The extensible part may have a breaking strength of 1500 N/5 cm.

### Embodiment 2

FIG. 8 is a schematic view of an extensible part of an airbag door hinge according to Embodiment 2 of the present invention, wherein the extensible part is stretched from an unstretched state to a stretched state until it is stretched to a limit. A direction of the double arrow in FIG. 8 is an extension direction. In this embodiment, a length of an axis b perpendicular to the extension direction in the mesh opening 5 is great than a length of an axis a parallel to the extension direction in the mesh opening 5. That is, the mesh opening 5 may have an elliptical shape. When the airbag door opens, the airbag door hinge is stretched by the deformation of the mesh opening 5, serving an extension function. When the mesh opening 5 is stretched to a limit, the fabric layer begins to exert a restraining effect on the airbag door.

The yarns are woven using the weaving mode in FIG. 4A. The second yarn and the third yarn each have an included angle of 30° with the extension direction.

A ratio of the length of the axis a parallel to the extension direction to the length of the axis b perpendicular to the extension direction is 1:2. The axis a may have a length of 2 mm. The axis b may have a length of 4 mm. An edge perpendicular to the extension direction in the mesh opening may have a length of 4 mm, and an edge in the extension direction in the mesh opening may have a length of 2 mm. The mesh opening may have an area of about 7 mm2. The extensible part may have an opening density of 5 openings/cm2. The extensible part may have a through-opening rate of 30%.

The first yarn, the second yarn and the third yarn may all use polyester yarn 300D. The extensible part may have an extension rate of 200% in the extension direction. The extensible part may have a breaking strength of 800 N/5 cm.

### Embodiment 3

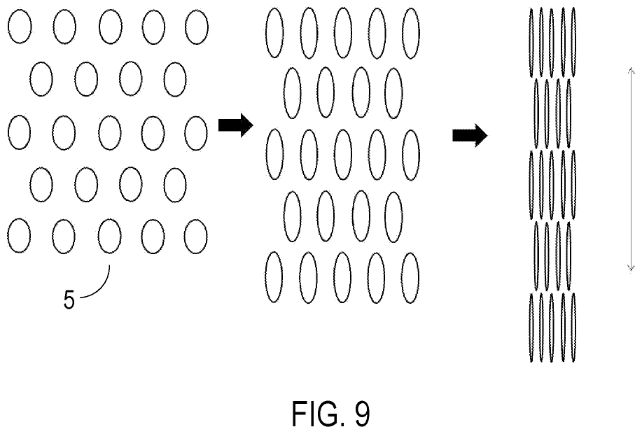

FIG. 9 is a schematic view of an extensible part of an airbag door hinge according to Embodiment 3 of the present invention, wherein the extensible part is stretched from an unstretched state to a stretched state until it is stretched to a limit. A direction of the double arrow in FIG. 9 is an extension direction. In this embodiment, a length of an axis b perpendicular to the extension direction in the mesh opening 5 is less than a length of an axis a parallel to the extension direction in the mesh opening 5. That is, the mesh opening 5 may have an elliptical shape. When the airbag door opens, the airbag door hinge is stretched by the deformation of the mesh opening 5, serving an extension function. When the mesh opening 5 is stretched to a limit, the fabric layer begins to exert a restraining effect on the airbag door.

The yarns are woven using the weaving mode in FIG. 4A. The second yarn and the third yarn each have an included angle of 15° with the extension direction.

A ratio of the length of the axis a parallel to the extension direction to the length of the axis b perpendicular to the extension direction is 2:1. The axis a may have a length of 4 mm. The axis b may have a length of 2 mm. An edge perpendicular to the extension direction in the mesh opening may have a length of 2 mm, and an edge in the extension direction in the mesh opening may have a length of 4 mm. The mesh opening may have an area of about 7 mm2. The extensible part may have an opening density of 5 openings/cm2. The extensible part may have a through-opening rate of 30%.

The first yarn, the second yarn and the third yarn may use polyester yarn 300D. The extensible part may have an extension rate of 100% in the extension direction. The extensible part may have a breaking strength of 2000 N/5 cm.

### Exemplary Embodiments—B

The present invention relates to a component for a vehicle interior comprising an airbag door, a load-bearing component surrounding the airbag door, and an airbag door hinge. The airbag door hinge may be configured to connect the airbag door and the load-bearing component. The airbag door hinge may comprise a fabric layer. The fabric layer may comprise an extensible part comprising, based on a direction perpendicular to an extension direction of the extensible part, first zones and second zones disposed alternately, and the first zones may comprise mesh openings arranged at intervals.

According to an exemplary embodiment, the mesh openings have a substantially elliptical shape, a ratio of a length of an axis parallel to the extension direction to a length of an axis perpendicular to the extension direction in the mesh openings is 1:10 to 10:1, preferably 1:5 to 5:1, and more preferably 1:2 to 2:1.

According to an exemplary embodiment, a plurality of the mesh openings are arranged in the extension direction to form a plurality of rows of the mesh openings, and each row of the mesh openings are staggered with adjacent rows of the mesh openings.

According to an exemplary embodiment, the fabric layer is woven from yarns.

According to an exemplary embodiment, the extensible part may comprise a first yarn, a second yarn and a third yarn. The first yarn may be arranged in a direction perpendicular to the extension direction, the second yarn and the third yarn may be routed in a direction perpendicular to the extension direction in a zigzag mode and may be wound with the first yarn, and the second yarn may be cross-arranged with the third yarn.

According to an exemplary embodiment, boundaries of the first zone and the second zone are defined by the first yarn and the second and/or third yarn wound therewith and thereby forming loops.

According to an exemplary embodiment, the first zones comprise the second yarn and/or the third yarn between two adjacent mesh openings, and the second yarn and the third yarn are routed in a direction perpendicular to the extension direction in a zigzag mode.

According to an exemplary embodiment, the second zones comprise the second yarn and/or the third yarn, and the second yarn and the third yarn are routed in a direction perpendicular to the extension direction in a zigzag mode.

According to an exemplary embodiment, the mesh openings are bounded in the extension direction by the first yarn, the second yarn and the third yarn.

According to an exemplary embodiment, the mesh openings are bounded by the crossed second and third yarn in a direction perpendicular to the extension direction.

According to an exemplary embodiment, the second yarn and/or the third yarn each have an included angle of 1-89°, preferably 1-45°, with the extension direction.

According to an exemplary embodiment, the fabric layer is woven from yarns of one or more materials.

According to an exemplary embodiment, the extensible part may have an opening density of 1-10 openings/cm2.

According to an exemplary embodiment, an axis parallel to the extension direction in the mesh openings may have a length of 1-10 mm.

According to an exemplary embodiment, an axis perpendicular to the extension direction may have a length of 1-10 mm.

According to an exemplary embodiment, an edge perpendicular to the extension direction in the mesh openings may have a length of 1-10 mm.

According to an exemplary embodiment, an edge in the extension direction in the mesh openings may have a length of 1-10 mm.

According to an exemplary embodiment, the mesh openings have an area of 1-100 mm2.

According to an exemplary embodiment, the extensible part may have a through-opening rate of 5-80%.

According to an exemplary embodiment, the extensible part may have an extension rate of 20-200% in the extension direction.

According to an exemplary embodiment, the extensible part may have a breaking strength of 500-50,000 N/5 cm in the extension direction.

According to an exemplary embodiment, the airbag door hinge may comprise a protective layer covering the fabric layer.

According to an exemplary embodiment, the load-bearing component comprises a framework and an airbag frame integrally formed with the framework. The framework may define an opening for deployment of an airbag therethrough, the airbag door may be configured to cover the opening, and the airbag door hinge may be configured to connect with the airbag door and the framework or the airbag frame.

According to an exemplary embodiment, the load-bearing component comprises a framework and an airbag frame connected with the framework. The framework may define an opening for deployment of an airbag therethrough, the airbag door may be configured to cover the opening, and the airbag door hinge may be configured to connect with the airbag door and the airbag frame.

According to the airbag door hinge in the component for a vehicle interior of the present invention, the extensible part woven from yarns may have high extensibility to prevent the airbag door from being separated from the load-bearing component, and the extensible part can be structurally deformed due to the arrangement of a plurality of mesh openings to further increase the extensibility of the extensible part, thereby solving the following problem that is likely to occur when the airbag door opens due to a low extension rate in the prior art: the airbag door hinge is broken due to excessive shearing tension and the airbag door flies out when the airbag door is under tension in the deployment process, which results in safety risks. The airbag door hinge in the component for a vehicle interior of the present invention can reduce the tension applied to the extensible part in the opening process of the airbag door, so that the risk that the fabric layer is broken due to excessive shearing tension applied to the fabric layer is avoided.

The component for a vehicle interior of the present invention has the advantages of being easy to manufacture, being safe and practical, and being suitable for large-scale production.

According to an exemplary embodiment as shown schematically in FIGS. 2A-2D, 3, 4A-4B, 5, 6A-6C, 7, 8, 9 and 10A-10D, a component for a vehicle interior may comprise an airbag door, a load-bearing component surrounding the airbag door, and an airbag door hinge. The airbag door hinge may be configured for connecting with the airbag door and the load-bearing component. The airbag door hinge may comprise a fabric layer. The fabric layer may comprise an extensible part comprising, based on a direction perpendicular to an extension direction of the extensible part, first zones and second zones disposed alternately, and the first zones may comprise mesh openings arranged at intervals. The mesh openings may comprise a substantially elliptical shape, and a ratio of a length of an axis parallel to the extension direction to a length of an axis perpendicular to the extension direction in the mesh openings may be 1:10 to 10:1, preferably 1:5 to 5:1, and more preferably 1:2 to 2:1. A plurality of the mesh openings may be arranged in the extension direction to form a plurality of rows of the mesh openings, and each row of the mesh openings may be staggered with adjacent rows of the mesh openings. The fabric layer may be woven from yarns. The extensible part may comprise a first yarn, a second yarn and a third yarn. The first yarn may be arranged in a direction perpendicular to the extension direction. The second yarn and the third yarn may be routed in a direction perpendicular to the extension direction in a zigzag mode and may be wound with the first yarn. The second yarn may be cross-arranged with the third yarn. Boundaries of the first zone and the second zone may be defined by the first yarn and the second and/or third yarn wound therewith and thereby forming loops. The first zones may comprise the second yarn and/or the third yarn between two adjacent mesh openings, and the second yarn and the third yarn may be routed in a direction perpendicular to the extension direction in a zigzag mode. The second zones may comprise the second yarn and/or the third yarn, and the second yarn and the third yarn may be routed in a direction perpendicular to the extension direction in a zigzag mode. The mesh openings may be bounded in the extension direction by the first yarn, the second yarn and the third yarn. The mesh openings may be bounded by the crossed second and third yarn in a direction perpendicular to the extension direction. The second yarn and/or the third yarn may each have an included angle of 1-89°, preferably 1-45°, with the extension direction. The extensible part may have an opening density of 1-10 openings/cm2. The mesh openings may have an area of 1-100 mm2. The extensible part may have a through-opening rate of 5-80%. The axis parallel to the extension direction in the mesh openings may have a length of 1-10 mm. The axis perpendicular to the extension direction in the mesh openings may have a length of 1-10 mm. An edge perpendicular to the extension direction in the mesh openings may have a length of 1-10 mm. An edge in the extension direction in the mesh openings may have a length of 1-10 mm. The extensible part may have an extension rate of 20-200% in the extension direction. The extensible part may have a breaking strength of 500-50,000 N/5 cm in the extension direction. The airbag door hinge may comprise a protective layer covering the fabric layer. The load-bearing component may comprise a framework and an airbag frame integrally formed with the framework. The framework may define an opening for deployment of an airbag therethrough. The airbag door may be configured to cover the opening. The airbag door hinge may be configured for connecting with the airbag door and the framework or the airbag frame. The load-bearing component may comprise a framework and an airbag frame connected with the framework. The framework may define an opening for deployment of an airbag therethrough. The airbag door may be configured to cover the opening. The airbag door hinge may be configured for connecting with the airbag door and the airbag frame.

### Exemplary Embodiments—C

Vehicle airbag assemblies are commonly used trims for a vehicle interior, which are vehicle accessories for protecting a driver and a passenger. The vehicle airbag assemblies include a vehicle airbag assembly mounted in a steering wheel to protect a driver, and an airbag assembly mounted in an instrument panel to protect a passenger.

The vehicle airbag assemblies mainly comprise an airbag, an airbag door covering the airbag, and an airbag door hinge connecting the airbag door to a load-bearing component. When the airbag assembly is triggered, the airbag door opens, so that the airbag can be ejected and the airbag door hinge can guide the airbag door when opening.

Depending on a size of the airbag door used, different forces act on the airbag door hinge when the airbag assembly is triggered. The larger the size or the heavier the weight of the airbag door is, the greater the force acting on the airbag door hinge is.

For the airbag door hinge, in one aspect, it is necessary to ensure that the airbag door is easy to open when the airbag assembly is triggered; in another aspect, in order not to endanger persons in the airbag area, it is necessary to ensure that the airbag door does not come loose from the load-bearing component surrounding the airbag door. There are airbag door hinges made of a fabric woven from warp and weft yarns. CN 208774709 U discloses an airbag door hinge with a double-layer structure having a first textile layer and a second textile layer; the first textile layer and the second textile layer are connected by a plurality of connecting components; a weft spacing L between two adjacent connecting components in a weft direction is 5-200 mm.

According to an exemplary embodiment as shown schematically in FIG. 5, an extensible part of an airbag door hinge may comprise mesh openings.

According to an exemplary embodiment as shown schematically in FIGS. 6A-6C, an extensible part of an airbag door hinge may comprise yarns.

According to an exemplary embodiment as shown schematically in FIG. 7, the extensible part may be stretched from an unstretched state to a stretched state until it is stretched to a limit.

According to an exemplary embodiment as shown schematically in FIG. 8, the extensible part may be stretched from an unstretched state to a stretched state until it is stretched to a limit.

According to an exemplary embodiment as shown schematically in FIG. 9, the extensible part may be stretched from an unstretched state to a stretched state until it is stretched to a limit.

According to an exemplary embodiment, a component for a vehicle interior may comprise an airbag door A1, a load-bearing component A2 surrounding the airbag door, and an airbag door hinge C1. The airbag door hinge may be configured to connect the airbag door and the load-bearing component. The airbag door hinge may comprise a fabric layer 1. The fabric layer 1 may comprise an extensible part comprising, based on a direction perpendicular to an extension direction of the extensible part, first zones Z1 and second zones Z2 disposed alternately, and the first zones Z1 may comprise mesh openings 5 arranged at intervals. The extensible part may be structurally deformed due to the arrangement of a plurality of the mesh openings, which may increase the extensibility of the extensible part, and may reduce the tension applied to the extensible part in the opening process of the airbag door, so that the risk that the fabric layer is broken due to excessive shearing tension applied thereto may be avoided.

TABLE A
REFERENCE SYMBOL LIST

| | REFERENCE |
|---|---|
| ELEMENT, PART OR COMPONENT | SYMBOL |
| Vehicle | V |
| Interior | I |
| instrument panel | IP |
| Door | DL |
| Recess | TR |
| airbag door | ABD |
| Airbag | AB |
| fabric layer | 1 |
| Mesh | MH |
| Grid | GD |
| first segment (of yarns) | S1 |
| second segment (of yarns) | S2 |
| first row (of first segments) | R1 |
| second row (of second segments) | R2 |
| third row (of first segments) | R3 |
| protective layer | 3 |
| opening in mesh | 5 |
| row of mesh opening | L, M, N |
| first yarn | 7 |
| second yarn | 9 |
| third yarn | 11 |
| first zone | Z1 |
| second zone | Z2 |
| third zone | Z3 |
| included angle | θ |
| Axis | A |
| Axis | B |
| Length | A |
| Length | B |
| airbag door | A1 |
| load-bearing component | A2 |
| airbag door hinge | C1 |
| Framework | A21 |
| airbag frame | A22 |
| Opening | O |
| Airbag | G |
| load-bearing component foam layer | A23 |
| load-bearing component skin layer | A24 |
| airbag frame | A22 |
| airbag door substrate | A12 |
| airbag door foam layer | A13 |
| airbag door skin layer | A14 |
| fixed segment (of airbag door hinge C1) | C10 |
| fixed segment (of airbag door hinge C1) | C13 |
| hinge segment (of airbag door hinge C1) | C11 |
| weakened zone (of framework A21) | W |
| fixed segment (of the hinge C1) | C12 |
| reinforcing door | A11 |

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. A component for a vehicle interior comprising:
an airbag door;
a load-bearing component surrounding the airbag door, and
an airbag door hinge coupled with the airbag door and the load-bearing component;
wherein the airbag door hinge comprises a fabric layer configured to extend in an extension direction during deployment of an airbag;
wherein the fabric layer comprises a mesh comprising a first segment of yarns and a second segment of yarns;
wherein the mesh comprises a grid comprising multiple first segments and multiple second segments.

2. The component of claim 1 wherein the first segment of yarns comprises a density of yarns different than a density of yarns of the second segment of yarns.

3. The component of claim 1 wherein the grid comprises a first row of first segments spaced from one another by openings in the mesh and a second row of second segments adjacent one another.

4. The component of claim 3 wherein the grid comprises a third row of first segments spaced from one another by openings in the mesh; wherein the first row is separated from the third row by the second row.

5. A component for a vehicle interior comprising:
an airbag door;
a load-bearing component surrounding the airbag door; and
an airbag door hinge coupled with the airbag door and the load-bearing component;
wherein the airbag door hinge comprises a fabric layer configured to extend in an extension direction during deployment of an airbag;
wherein the fabric layer comprises a mesh comprising a grid;
wherein the grid comprises a first yarn extending in a first direction, a second yarn extending in a second direction generally perpendicular to the first direction and a third yarn extending in the second direction.

6. The component of claim 5 wherein the second yarn and the third yarn are wound with the first yarn.

7. The component of claim 5 wherein the second yarn and the third yarn extend in a zig zag to facilitate compression of the fabric layer.

8. The component of claim 5 wherein the second yarn is arranged across the third yarn.

9. The component of claim 5 wherein the grid comprises a first zone comprising openings in the grid, a third zone comprising openings in the grid offset from the openings of the first zone, and a second zone separating the first zone and the third zone.

10. A component for a vehicle interior comprising:
an airbag door;
a load-bearing component surrounding the airbag door; and
an airbag door hinge;
wherein the airbag door hinge is configured for connecting with the airbag door and the load-bearing component;
wherein the airbag door hinge comprises a fabric layer;
wherein the fabric layer comprises an extensible part comprising, based on a direction perpendicular to an extension direction of the extensible part, first zones and second zones disposed alternately;
wherein the first zones comprise mesh openings arranged at intervals.

11. The component of claim 10 wherein the extensible part comprises a first yarn, a second yarn and a third yarn; wherein the first yarn is arranged in a direction perpendicular to the extension direction; wherein the second yarn and the third yarn are routed in a direction perpendicular to the extension direction in a zigzag mode and are wound with the first yarn; and
wherein the second yarn is cross-arranged with the third yarn.

12. The component of claim 11 wherein boundaries of the first zone and the second zone are defined by the first yarn and the second and/or third yarn wound therewith and thereby forming loops.

13. The component of claim 11 wherein the first zones comprise the second yarn and/or the third yarn between two adjacent mesh openings; wherein the second yarn and the third yarn are routed in a direction perpendicular to the extension direction in a zigzag mode.

14. The component of claim 11 wherein the second zones comprise the second yarn and/or the third yarn; wherein the second yarn and the third yarn are routed in a direction perpendicular to the extension direction in a zigzag mode.

15. The component of claim 11 wherein the mesh openings are bounded in the extension direction by the first yarn, the second yarn and the third yarn, and/or the mesh openings are bounded by the crossed second and third yarn in a direction perpendicular to the extension direction.

16. The component of claim 10 wherein the extensible part has an opening density of 1-10 openings/cm2, and/or the mesh openings have an area of 1-100 mm2, and/or the extensible part has a through-opening rate of 5-80%.

17. The component of claim 10 wherein an axis parallel to the extension direction in the mesh openings has a length of 1-10 mm, and/or an axis perpendicular to the extension direction in the mesh openings has a length of 1-10 mm, and/or an edge perpendicular to the extension direction in the mesh openings has a length of 1-10 mm, and/or an edge in the extension direction in the mesh openings has a length of 1-10 mm.

18. The component of claim 10 wherein the extensible part has an extension rate of 20-200% in the extension direction, and/or the extensible part has a breaking strength of 500-50,000 N/5 cm in the extension direction.

19. The component of claim 10 wherein the airbag door hinge comprises a protective layer covering the fabric layer.

20. The component of claim 10 wherein the load-bearing component comprises a framework and an airbag frame integrally formed with or connected with the framework; wherein the framework defines an opening for deployment of an airbag therethrough; wherein the airbag door is configured to cover the opening; wherein the airbag door hinge is configured for connecting with the airbag door and the framework or the airbag frame.
